(19) United States
(12) Patent Application Publication
(10) Pub. No.: US 2006/0215920 A1
(43) Pub. Date: Sep. 28, 2006

(54) Image processing apparatus, image processing method, and storage medium storing programs therefor

(75) Inventor: Taro Yokose, Nakai-machi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/236,764

(22) Filed: Sep. 28, 2005

(30) Foreign Application Priority Data
Mar. 23, 2005 (JP) 2005-083505

(51) Int. Cl. G06K 9/36

(52) U.S. Cl. 382/238

(57) ABSTRACT

An image processing apparatus disclosed herein includes an extracting unit that extracts a pixel cluster of a predetermined size from input image data, and a coding unit that codes the input image data, based on correlation between pixel clusters extracted by the extracting unit.

### BACKGROUND OF THE INVENTION

1. Field of the Invention

The present invention relates to an image processing method to compress or decompress image data.

2. Description of the Related Art

As coding methods that exploit autocorrelation of data, for example, run length coding, JPEG-LS, LZ coding (Ziv-Lempel coding), etc. are available. Particularly for image data, adjacent pixels are very closely correlated to each other. Therefore, by taking advantage of such correlation, image data can be coded at a high compression rate.

And there is known a predictive coding method using plural prediction parts.

### SUMMARY OF THE INVENTION

The present invention has been made in view of the foregoing background and provides an image compression apparatus that compresses image data at a high speed and a high compression rate.

[Image Compression Apparatus]

An image compression apparatus of the present invention includes an extracting unit that extracts a pixel cluster of a predetermined size from input image data and a coding unit that codes the input image data, based on correlation between pixel clusters extracted by the extracting unit.

### BRIEF DESCRIPTION OF THE DRAWINGS

The above and other aspects, features, and advantages of the present invention will be more apparent from the following description of an illustrative embodiment thereof, taken in conjunction with the accompanying drawings, wherein:

FIG. 1 illustrates a hardware configuration of an image processing apparatus to which an image processing method of the present invention is applied, configured with a controller and peripherals;

FIG. 2 illustrates a functional structure of a first coding program that implements an image processing method (coding method) of the present invention when executed by the controller (in FIG. 1);

FIGS. 3A through 3D explain a method of generating data set values per block, wherein FIG. 3A illustrates a block of 2 by 2 pixels, FIG. 3B illustrates a data set (before subjected to resolution changing) for a block of two by two pixels, FIG. 3C illustrates a data set after subjected to resolution changing, and FIG. 3D illustrates a block of 2 by 1 pixels;

FIG. 4 illustrates a more detailed structure of a predictive coding part (in FIG. 2);

FIGS. 5A through 5C explain a coding process that is performed by the predictive coding part (FIG. 4), wherein FIG. 5A illustrates the positions of blocks which are referred to by prediction parts, FIG. 5B illustrates codes respectively mapped to the reference blocks, and FIG. 5C illustrates coded data that is generated by a code generating part;

FIG. 6 is a flowchart of a coding process by the coding program (FIG. 2);

FIG. 7 illustrates a functional structure of a decoding program that implements an image processing method (decoding method) of the present invention when executed by the controller (in FIG. 1);

FIG. 8 illustrates a structure of a second coding program;

FIG. 9 illustrates a more detailed structure of a filter processing part (in FIG. 8);

FIGS. 10A and 10B explain a prediction error decision operation by a prediction error decision part (in FIG. 9), wherein FIG. 10A illustrates tolerances set for each color component and FIG. 10B illustrates examples of prediction error evaluation made by the prediction error decision part; and

FIG. 11 is a flowchart of a coding process by a second coding program (FIG. 8).

### DETAILED DESCRIPTION OF THE INVENTION

[Background and Overview]

To help understanding of the present invention, its background and overview will first be described.

A predictive coding method such as, for example, LZ coding, generates predicted data for a pixel by making reference to pixel values of pixels in predetermined reference positions and, if the predicted data of a reference pixel matches the image data of the pixel of interest, codes the reference position or the like (hereinafter referred to as reference information) of the matched predicted data as data for coding the pixel of interest.

It is thus necessary to determine whether the image data of a pixel of interest matches its predicted data for each pixel.

Now, an image processing apparatus 2 in which the present invention is embodied partitions an input image into blocks of a predetermined size (pixel clusters, each made up of a predetermined number of pixels) and codes the image data by utilizing correlations between respective blocks. More specifically, this image processing apparatus 2 assembles the pixel values of pixels constituting a block into one data set, thus generating data set values, and carries out a predictive coding process, regarding the data set values of one block as the pixel values of one pixel.

Thus, a match decision operation with regard to plural pixels can be performed at a time and this can speed up the coding process.

For color images, an effect of a gradation (pixel) value change is easy to appear in some color components, whereas such effect is hard to appear in other color components. For image data, for example, in a YCbCr color space, a Y component gradation value change is liable to appear more easily than a Cb and Cr component gradation value change. For image data in an RGB color space, an R and G component gradation value change is liable to appear more easily than a B component gradation value change.

The image processing apparatus 2 in which the present invention is embodied decreases the resolution of some of the color components of plural pixels constituting a block lower than the resolution of the remaining color component before carrying out coding. More specifically, the image processing apparatus 2 decrease the resolution of the color components in which the effect of a pixel value change is hard to appear.

By this resolution changing, the data amount of a data set is reduced and a higher compression rate can be achieved.

It is conceivable to partition a color image into images of plural color components, perform sub-sampling on some of the images of the color components, and perform coding for each of the images of the color components (sub-sampling in plane-sequential coding). In this case, however, coding based on correlation is possible only with correlations in each color component image. In other words, correlations between each color component image cannot be used for coding.

Now, the present image processing apparatus 2 generates a data set for every block of a predetermined size, the data set containing the values of plural pixels and plural color components, compares the generated data set values of one block to those of another block, makes a match decision, and codes matched data.

[Hardware Configuration]

Then, a hardware configuration of the image processing apparatus 2 of a first embodiment will be described.

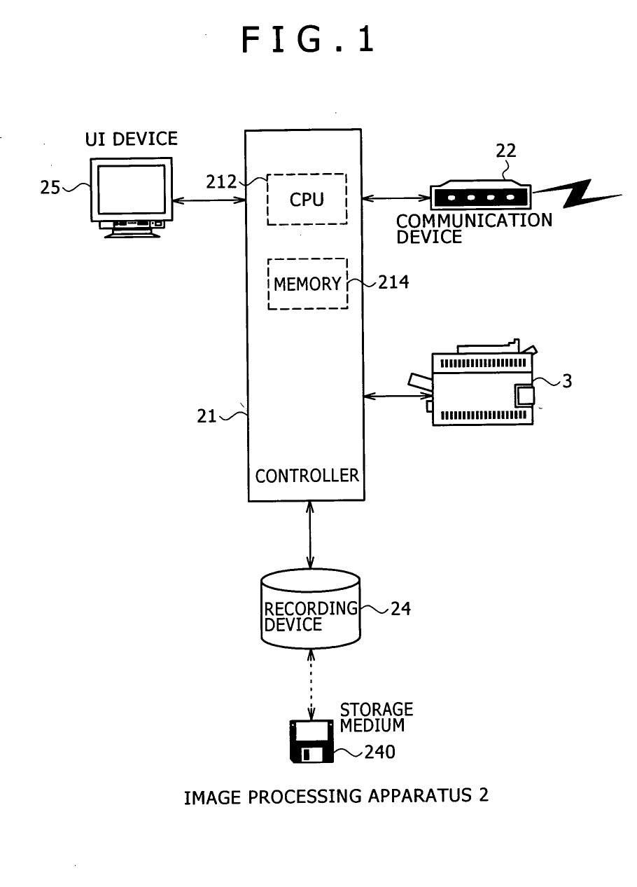

FIG. 1 illustrates the hardware configuration of the image processing apparatus 2 to which an image processing method of the present invention is applied, configured with a controller 21 and peripherals.

As illustrated in FIG. 1, the image processing apparatus 2 is composed of the controller 21 which includes a CPU 212, a memory 214 and other components, a communication device 22, a recording device 24 such as an HDD or CD player, and a user interface (UI) device 25 which includes an LCD display or CRT display with a keyboard, a touch panel, etc.

The image processing apparatus 2 is, for example, a general-purpose computer in which an coding program 5 (which will be described later) and a decoding program 6 (which will be described later) involved in the present invention are installed as a part of a printer driver. It acquires image data via the communication device 22 or recording device 24, codes or decodes the acquired image data, and sends the coded or decoded image data to a printer 3.

[Coding Program]

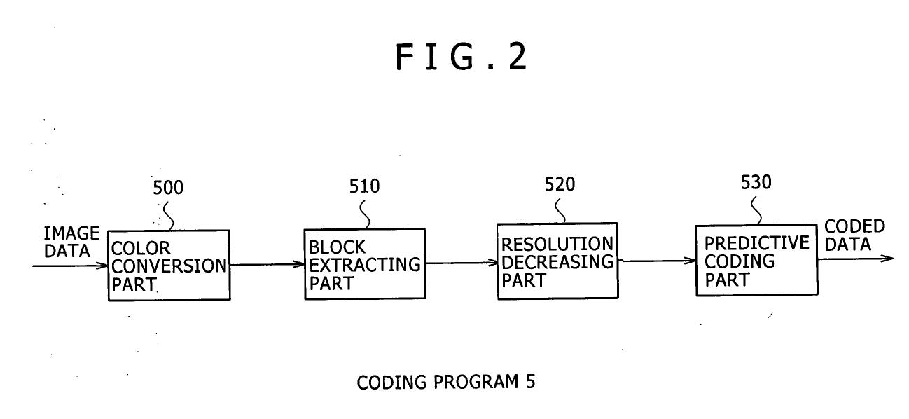

FIG. 2 illustrates a functional structure of a first coding program 5 that implements an image processing method (coding method) of the present invention when executed by the controller 21 (in FIG. 1).

As illustrated in FIG. 2, the first coding program 5 has a color conversion part 500, a block extracting part 510, a resolution decreasing part 520, and a predictive coding part 530.

In the coding program 5, the color conversion part 500 converts the color space of input image data.

For example, the color conversion part 500 converts image data in a color space that is used for scanning or outputting an image (e.g., an RGB color space, CMYK color space, etc.) into image data in a color space where a luminance component (or lightness component) is separate from other color components (e.g., chrominance components) (such as a YCbCr color space, Lab color space, Luv color space, and Munsell color space).

The color conversion part 500 in this example converts image data represented in the RGB color space into image data in the YCbCr color space.

The block extracting part 510 extracts a block of a predetermined size from the input image data and generates values in a data set based on the gradation values (pixel values) of the block extracted. The data set values are generated based on the gradation values (pixel values) of plural pixels constituting the block and assembled so that they can reproduce the pixel values of the pixels. If the input image data represents a color image, the data set values are generated based on the gradation values (pixel values) for plural color components and assembled so that they can reproduce the gradation values for each color component of the pixels.

The resolution decreasing part 520 performs resolution changing processing on image data for some of the color components of the input image data.

For example, the resolution decreasing part 520 performs the resolution changing processing to decrease the resolution on image data for color components in which a pixel value change is harder to appear than in other components.

The resolution decreasing part 520 in this example performs the resolution changing processing to decrease the resolution on image data for Cb and Cr components out of the image data converted to the YCbCr color space by the color conversion part 500.

As the resolution changing processing, the resolution decreasing part 520 calculates an average (an average of gradation values), mode, or median of the plural pixels constituting a block.

The predictive coding part 530 compares the data set values of one block to those of another block and carries out a predictive coding process. When coding the data set values of a block of interest, the predictive coding process in this example is a coding method utilizing correlation between the data set values of the block of interest and those of another block. Therefore, the predictive coding process is capable of, for example, sequential coding on a block-by-block basis (dot-sequential coding), unlike JPEG image coding or the like which codes image data for each color component plane (plane-sequential coding).

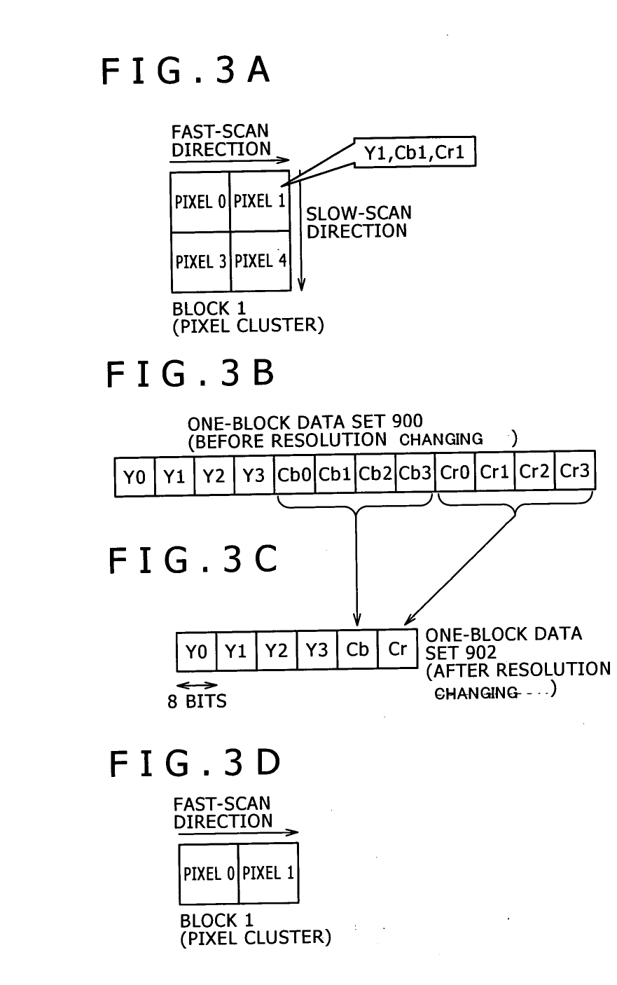

FIGS. 3A through 3D explain a method of generating data set values per block, wherein FIG. 3A illustrates a block of 2 by 2 pixels, FIG. 3B illustrates a data set 900 (before subjected to resolution changing) for a block of 2 by 2 pixels, FIG. 3C illustrates a data set 902 after subjected to resolution changing, and FIG. 3D illustrates a block of 2 by 1 pixels.

As illustrated in FIG. 3A, the block extracting part 510 (in FIG. 2) partitions input image data into blocks of 2 by 2 pixels. A block of 2 by 2 pixels is an image area of four pixels, that is, two pixels in a vertical direction by two pixels in a horizontal direction. A block in this example is an image area of four pixels, two pixels in the fast-scan direction by two pixels in the slow-scan direction. Each block contains four pixels, pixel 0, pixel 1, pixel 2, and pixel 3. Each pixel contains Y, Cb, and Cr components in the YCbCr color space.

The block extracting part 510 sorts the pixel values of the pixels constituting each block by color component and arranges them in lots of each color component, as illustrated in FIG. 3B. In this example, first, “Y0” (which represents Y component of pixel 0) to “Y3” (which represents Y component of pixel 3) are arranged, followed by “Cb0” (which represents Cb component of pixel 0) to “Cb3” (which represents Cb component of pixel 3), further followed by “Cr0” (which represents Cr component of pixel 0) to “Cr3” (which represents Cr component of pixel 3).

Each value of Y0 to Cr3 is made up of eight bits in this example. Thus, the data set 900 before subjected to resolution changing is a sequence of 96 bits.

The resolution decreasing part 520 (in FIG. 2) converts the Cb components portion and the Cr components portion of the image data (data set 900 illustrated in FIG. 3B) generated by sorting by the block extracting part 510 into one Cb value and one Cr value, respectively, as illustrated in FIG. 3C. In this example, a “Cb” shown in FIG. 3C is an average of Cb0 to Cb3 and a “Cr” in FIG. 3C is an average of Cr0 to Cr3.

As a result, the data set 902 after subjected to resolution changing becomes a sequence of 48 bits.

The block extracting part 510 may extract a block of two pixels, two pixels in the fast-scan direction by one pixel in the slow-scan direction, as illustrated in FIG. 3D. This is profitable because one line buffer is sufficient for buffering pixels per line in this case.

The shape of a block that is extracted by the block extracting part 510 is arbitrary; e.g., plural pixels which are apart from each other may be assembled into a block.

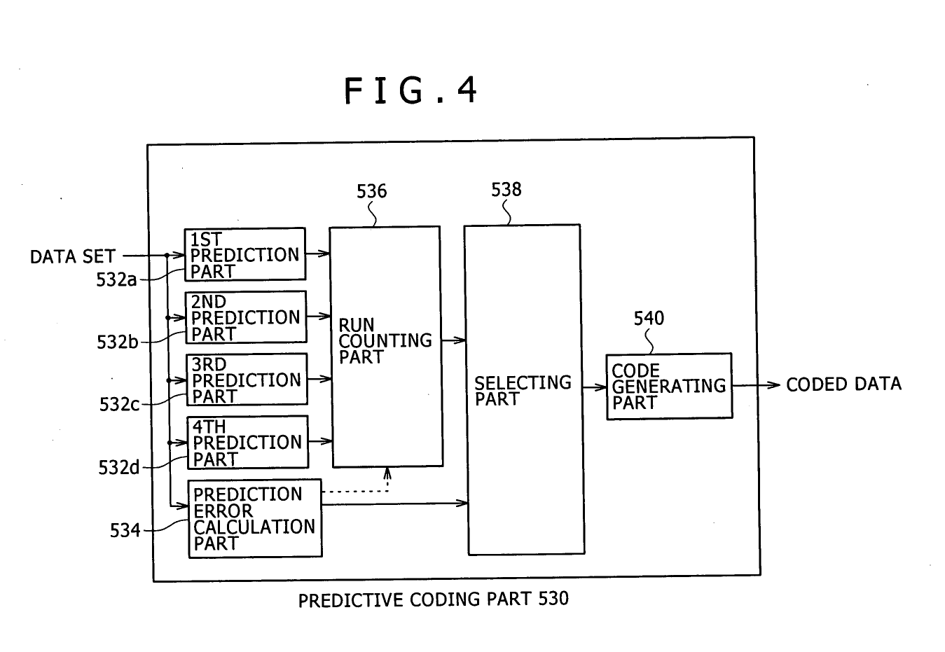

FIG. 4 illustrates a more detailed structure of a predictive coding part 530 (in FIG. 2).

As illustrated in FIG. 4, the predictive coding part 530 includes plural prediction parts 532 (a first prediction part 532a, a second prediction part 532b, a third prediction part 532c, and a fourth prediction part 532d), a prediction error calculation part 534, a run counting part 536, a selecting part 538, and a code generating part 540.

When coding the data set values of a block of interest, each prediction part 532 generates predicted data for the block of interest, using the data set values of another block, compares the generated predicted data to the data set values of the block of interest, and outputs the result of the comparison to the run counting part 536.

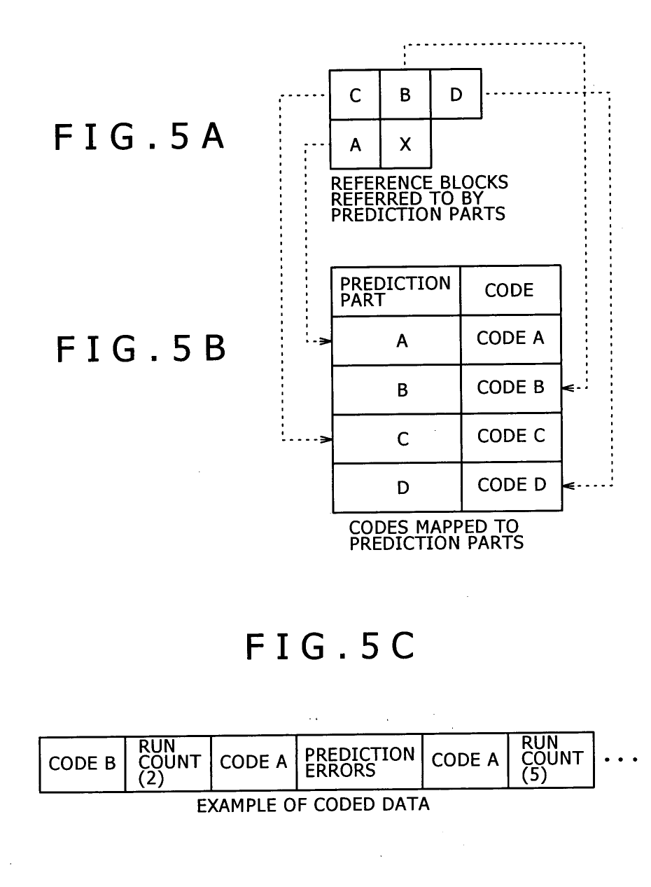

More specifically, the first to fourth prediction parts 532a to 532d respectively compare the data set values (predicted data in this example) of reference blocks A to D (which will be described later with reference to FIG. 5A) to the data set values of the block X of interest (which will be described later with reference to FIG. 5A). As a result, if data set values matching occurs (i.e., a prediction hit occurs), each prediction part outputs its prediction part ID which identifies itself to the run counting part 536. Otherwise, each prediction part outputs a mismatch result to the run counting part 536.

Although the plural prediction parts 532 are employed in this example, there may be provided at least one prediction part, for example, only the first prediction part 532a which makes reference to the reference block A.

The predication error calculation part 534 generates predicted data for the block of interest by a predetermined prediction method, calculates differences between the generated predicted data and the data set values of the block area of interest, and outputs the calculated differences as prediction errors to the selecting part 538.

More specifically, the prediction error calculation part 534 predicts the data set values of the block of interest, using the data set values of a block in a predetermined reference position, subtracts the predicted values from the actual data set values of the block of interest, and outputs results as prediction errors to the selecting part 538. The prediction method for the prediction error calculation part 534 is at least required to be correspondingly effected in decoding coded data that is finally generated.

The prediction error calculation part 534 in this example takes the data set values of the block (reference block A) in the same reference position as for the first prediction part 532a as predicted values and calculates differences between the predicted values and actual data set values (of the block X of interest) for each of the components (Y0 to Y3, Cb, and Cr).

If the reference block A does not exist, like in a case where the block of interest is the leftmost one, the prediction error calculation part 534 takes the data set values (predetermined) of a default block as predicted values and calculates prediction errors. Among the data set values of the default block, the values of the chrominance components are set to, for example, 0.

The run counting part 536 counts successive hits of the same prediction part ID and outputs the prediction part ID and the number of its successive hits to the selecting part 538.

If the results of all prediction parts 532 are no match between the predicted values and the data set values of the block of interest, the run counting part 536 in this example outputs the prediction part IDs and the numbers of their successive hits so far counted and held in its internal counter.

Based on the prediction part IDs and the numbers of their successive hits, input from the run counting part 536, and the prediction errors, input from the prediction error calculation part 534, the selecting part 538 selects a prediction part ID for which the number of successive hits is the greatest and outputs that prediction part ID and the number of its successive hits as well as the prediction errors as predicted data to the code generating part 540. A prediction part ID, the number of its successive hits, and prediction errors are concrete examples of data output as results of match decision making.

The code generating part 540 codes a prediction part ID, the number of its successive hits, and prediction errors, input from the selecting part 538, and outputs coded data to the communication device 22 (in FIG. 1) or the recoding device 24 (in FIG. 1) or the like.

FIGS. 5A through 5C explain a coding process that is performed by the predictive coding part 530 (FIG. 4), wherein FIG. 5A illustrates the positions of blocks which are referred to by the prediction parts 532, FIG. 5B illustrates codes respectively mapped to the reference blocks, and FIG. 5C illustrates coded data that is generated by the code generating part 540.

As illustrated in FIG. 5A, the blocks that are respectively referred to by the plural prediction parts 532 are positioned relatively to the block X of interest. Specifically, the reference block A for the first prediction part 532a is positioned at an upstream side (the left) of the block X of interest in the fast-scan direction. The reference blocks B to D for the second to fourth prediction parts 532b to 532d are positioned one first-scan line above the block X of interest (upstream in the slow-scan direction).

As illustrated in FIG. 5B, codes are respectively mapped-to the reference blocks A to D.

If a prediction made by any prediction part 532 (for its reference block) hits, the run counting part 536 (in FIG. 4) increments the number of successive hits of the ID of the prediction part 532 (its reference block) which has made the prediction hit. If no predictions made by the prediction parts 532 (for their reference blocks) hit, the run counting part 536 outputs the counted numbers of successive hits of prediction part IDs to the selecting part 538.

The code generating part 540 has mappings between the prediction parts 532 (reference positions) and the codes as illustrated in FIG. 5B and outputs a code mapped to a reference position whose data set values matches with the corresponding values of the block X of interest. The codes mapped to the reference positions are entropy codes that have been set according to the hit rate of each reference position and code length is determined, depending on the hit rate.

If matching of data set values with those of the block of interest continuously occurs in a same reference position, the code generating part 540 codes the number of successive hits (run count) of the ID of the prediction part for the reference position counted by the run counting part 536. This reduces the amount of codes to be output. In this way, when matching of data set values with those of the block of interest occurs in any reference position, the coding program 5 applies the code mapped to that reference position, if the matching continues, codes the count of successive matches in the same reference position, and, if no matching of data set values occurs in any reference position, codes the differences (prediction errors) between the data set values of the reference block in the predetermined reference position and those of the pixel X of interest, as illustrated in FIG. 5C.

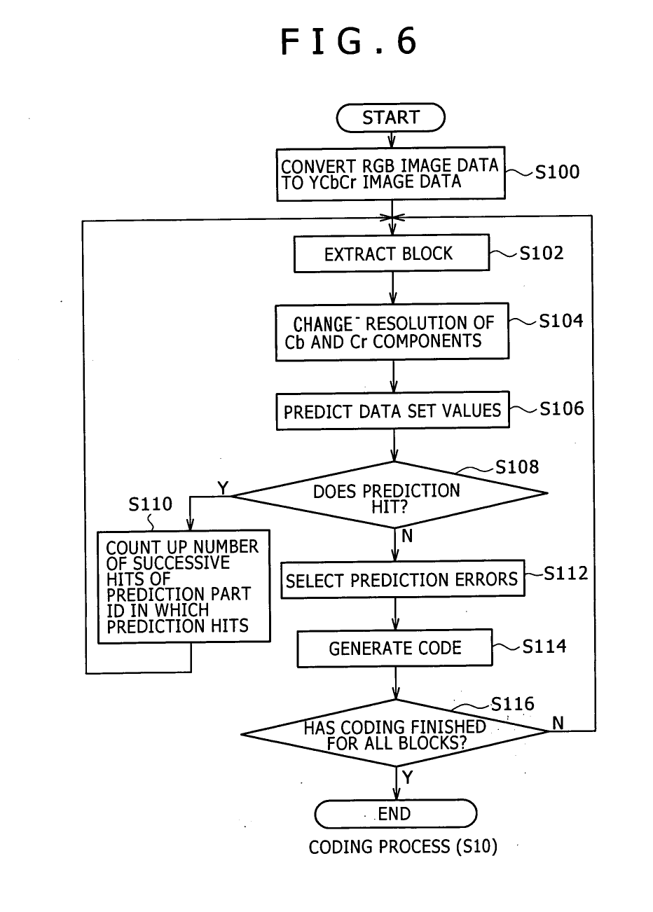

FIG. 6 is a flowchart of a coding process (S10) by the coding program 5 (FIG. 2).

As illustrated in FIG. 6, at step 100 (S100), the color conversion part 500 (in FIG. 2) converts input image data (image data in the RGB color space) into image data in the YCbCr color space and outputs the converted image data (image data in the YCbCr color space) to the block extracting part 510.

At step 102 (S102), the block extracting part 510 (in FIG. 2) selects a block of 2 by 2 pixels (FIG. 3A) in reading order out of the image data, input from the color conversion part 500, and sets the selected block as the block X of interest. The block X of interest contains four pixels, each having pixel values for Y, Cb, and Cr components.

The block extracting part 510 sorts and arranges the pixel values (Y, Cb, and Cr components) of the pixels constituting the block X of interest by color component, thus generating a data set 900 before subjected to resolution changing (FIG. 3B), and outputs the generated data set 900 to the resolution decreasing part 520.

At step 104 (S104), the resolution decreasing part 520 reduces the Cb components portion and the Cr components portion (lower 64 bits in this example) of the data set 900 (before resolution changing), input from the block extracting part 510, to a Cb component and a Cr component with decreased resolution. That is, the resolution decreasing part 520 performs resolution-decreasing processing on the Cb and Cr components of the data set 900 before resolution changing, generates a data set 902 after subjected to resolution changing (FIG. 3C), and outputs the generated data set 902 to the predictive coding part 530.

At step 106 (S106), the plural prediction parts 532 (in FIG. 4) provided in the predictive coding part 530 generate predicted data (data set values) for the block of interest, relative to the data set 902 of the block of interest, inputted from the resolution decreasing part 520 (that is, using buffered data set values (of a previously processed block)).

Meanwhile, the prediction error calculation part 534 (in FIG. 4) calculates differences between the data set values of the block of interest, which have been newly input, and the data set values of the reference block A for every eight bits (that is, for every component value), and outputs the calculated differences as prediction errors to the selecting part 538. Therefore, the prediction errors in this example are six error values.

At step 108 (S108), each prediction part 532 (in FIG. 4) compares the generated predicted data (the data set values of a reference block) to the data set values of the block X of interest, determines whether a match occurs, and outputs the result of the decision (the prediction part ID if the match occurs or a mismatch result) to the run counting part 536.

If the match between the data set values of the block X of interest and the predicted data occurs in any prediction part 532, the coding program 5 proceeds to step S110. If the match does not occur in any of the prediction parts 532, the coding program 5 proceeds to step S112.

At step 110 (S110), the run counting part 536 (in FIG. 4), when taking a prediction part ID inputted from any prediction part 532, increments the count value for the prediction part ID by one.

Then, the coding program 5 returns to S102 to perform the process for the next block.

At step 112 (S112), upon detecting that no prediction hits occur in any of the prediction parts 532, according to the results input from the prediction parts 532, the run counting part 536 outputs respective counts of all prediction part IDs to the selecting part 538.

When taking the input of the count values of all prediction part IDs from the run counting part 536, the selecting part 538 determines the greatest number of successive hits of a prediction part ID from the count values which have been inputted and outputs the greatest number of successive hits and the prediction part ID to the code generating part 540.

Then, the selecting part 538 outputs the prediction errors (i.e., prediction errors for the block X of interest for which no hits have occurred with the predictions made by any of the prediction parts 532), which have been input from the prediction error calculation part 534, to the code generating part 540.

At step 114 (S114), the code generating part 540 (in FIG. 4) codes the prediction part ID, the number of successive hits, and the prediction errors which have been inputted in order from the selecting part 538 and outputs coded data to the communication device 22 (in FIG. 1) or the recoding device 24 (in FIG. 1).

At step 116 (S116), the coding program 5 determines whether coding has finished for all blocks in the input image data. If there are one or more blocks for which coding is unfinished, the program returns to step S102 and repeats the process for the next block; otherwise, it ends the coding process (S10).

[Decoding Program]

Next, a decoding method for data coded as described above will be described.

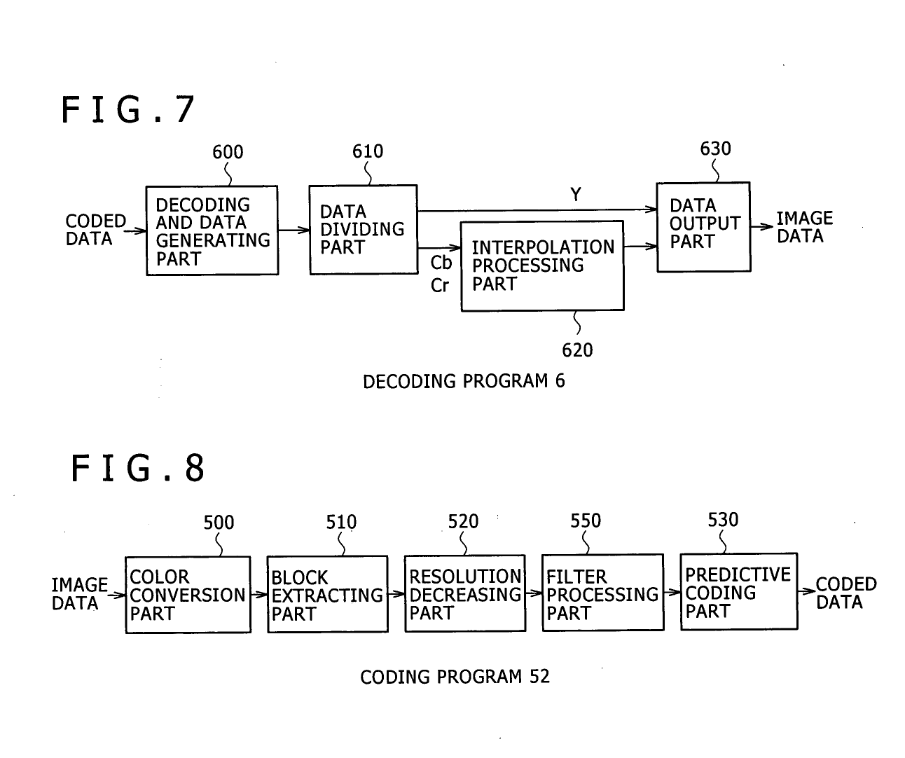

FIG. 7 illustrates a functional structure of a decoding program 6 that implements an image processing method (decoding method) of the present invention when executed by the controller 21 (in FIG. 1).

As illustrated in FIG. 7, the coding program 6 has a decoding and data generating part 600, a data dividing part 610, an interpolation processing part 620, and a data output part 630.

In the decoding program 6, the decoding and data generating part 600 has a table of mappings between the codes and the prediction part IDs (reference positions), which is the same as the one illustrated in FIG. 5B, and identifies a reference position corresponding to a code in the coded data that has been input to it. The decoding and data generating part 600 decodes the number of successive hits of a prediction part ID, prediction errors, etc. in the coded data that has been input to it.

Based on the reference position, the number of successive hits, and prediction errors thus decoded, the decoding and data generating part 600 then generates data set values of a block.

More specifically, the decoding and data generating part 600, after decoding a prediction part ID and the number of its successive hits, retrieves the data set values of the reference block corresponding to this prediction part ID (a reference block for which the data set has been decoded previously or a default block positioned at the upstream side of the block of interest in the image scan direction) and outputs the data set values repeatedly as many times as the number of successive hits.

The decoding and data generating part 600, after decoding prediction errors, outputs the sum of predicted data that has been fixed previously and the prediction errors as data set values. In this example, the decoding and data generating part 600 outputs the sum of the decoded prediction errors and the decoded data set values of the previous block (that is, the data set values of the reference block A) as the data set values of the block of interest.

The data dividing part 610 divides the data set values, inputted from the decoding and data generating part 600, in units of predetermined bits and extracts gradation values (pixel values) for each pixel and each color component.

The data dividing part 610 in this example divides the values in a data set 902 (FIG. 3C), sequentially input to it, into 8-bit component values.

The interpolation processing part 620 performs resolution changing processing on some (Cb and Cr components) of the color components in the decoded data set 902. For example, the interpolation processing part 620 may simply make as many copies of the Cb and Cr components as the number of Y components (that is, as the number of pixels constituting a block) or may interpolate the Cb and Cr components by, for example, a linear interpolation method or cubic convolution method, based on the Cb and Cr components in the neighboring blocks.

The data output part 630 rearranges and outputs the Y components of the pixels separated by the data dividing part 610 and the Cb and Cr components made by resolution changing by the interpolation processing part 620 in order of the pixels.

In this way, the decoding program 6 in this example has the capabilities to decode coded data generated by the above coding program 5 (FIG. 2), generate a data set 902, perform interpolation processing on the color components reduced by the resolution-decreasing processing in the generated data set 902, near perfectly reproduce a data set 900 (before resolution changing) and output decoded image data.

As described above, the image processing apparatus 2 of the present embodiment is capable of speeding up the coding process by coding a data set containing the pixel values of plural pixels as one block data.

For Cb and Cr components, a pixel value change is hard to appear as image quality deterioration, as compared with Y components. By reducing the Cb and Cr components to half in both fast and slow-scan directions, the image processing apparatus 2 of the present embodiment reduces the amount of data, or the size of a data set, and can achieve a higher compression rate.

### FIRST MODIFICATION EXAMPLE

Then, the following will describe examples of modification to the above embodiment.

While a lossless coding method is applied in the above-described embodiment, a lossy coding method is applied in a first modification example.

FIG. 8 illustrates a structure of a second coding program 52. Program components as shown in this figure, which are substantially identical to the components shown in FIG. 2, are assigned the same reference numbers.

As illustrated in FIG. 8, the second coding program 52 has the structure in which a filter processing part 550 is added to the first coding program 5.

In the second coding program 52, the filter processing part 550 carries out a gradation value change operation that changes the gradation range of each color component on image data which has been input to it (image data in the YCbCr color space, converted by the color conversion part 500, in this example).

More specifically, the filter processing part 550 reduces plural data values included in the image data to one data value to decrease the amount of the image data.

The filter processing part 550 may widen the gradation ranges of the color components substantially evenly. The gradation value change operation is not needed to be performed evenly across the entire image and a gradation range change may be carried out locally on the image data to reduce the amount of coded data that will be generated finally.

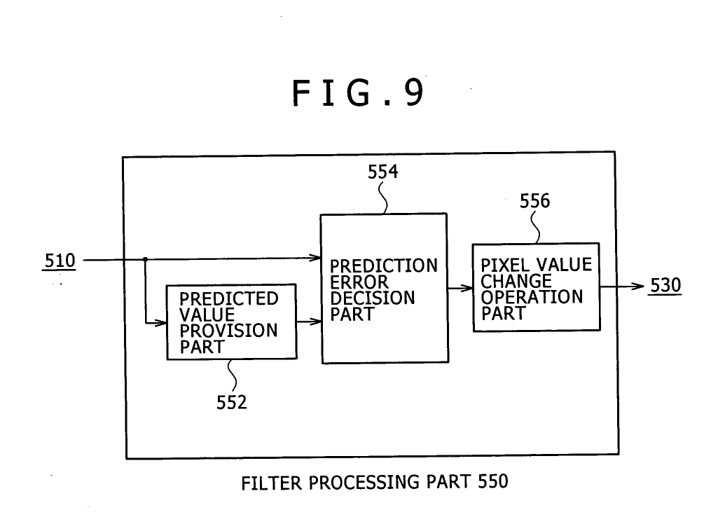

FIG. 9 illustrates a more detailed structure of the filter processing part 550 (in FIG. 8).

As illustrated in FIG. 9, the filter processing part 550 includes a predicted value provision part 552, a prediction error decision part 554, and a pixel value change operation part 556.

The predicted value provision part 552 generates predicted data for a block area of interest, based on image data which has been input to it, and provides the predicted data to the prediction error decision part 554.

The predicted value provision part 552 in this example generates predicted values (data set values) for the block X of interest in the same manner as done by the plural prediction parts 532 (in FIG. 4) provided in the predictive coding part 530, relative to the data set values of each block which are input from the block extracting part 510.

In this way, the filter processing part 550 performs an auxiliary operation to facilitate the predictive coding process which is performed by the predictive coding part 530 at the following stage and reduces the amount of coding in cooperation with this predictive coding part 530.

The prediction error decision part 554 compares the image data of the block area of interest which has been input to it to the predicted data for this block area of interest generated by the predicted value provision part 552 and determines whether to change the data values for this block area of interest.

More specifically, the prediction error decision part 554 calculates a differences between the data values of the block area of interest and the predicted values (predicted data) for this block area of interest and determines whether the calculated differences fall within predetermined tolerances. If the differences fall within the tolerances, the prediction error decision part 554 determines that the data values can be changed; if the differences exceed the tolerances, it inhibits changing the gradation values.

The prediction error decision part 554 in this example calculates differences between the data set values of the block X of interest and the plural predicted values for this block of interest (the data set values of the reference blocks A to D) for each component. If all differences for the components, thus calculated, fall within the tolerances, the prediction error decision part 554 permits replacing the data set values of this block of interest by the data set values of a reference block. If, among the differences calculated for this block of interest, one for any component goes beyond the tolerance, it inhibits replacement by the data set values of this reference block.

The components mentioned herein are “Y0” to “Y3,” “Cb,” and “Cr,” each being a sequence of 8 bits.

In other words, the prediction error decision part 554 evaluates prediction errors for each color component (Y, Cb, and Cr components in this example) and determines whether to change the data set values of the block of interest.

For example, the tolerance of the luminance component (or lightness component) is set narrower than the tolerances of other components (e.g., a hue component and others).

In this case, the prediction error decision part 554 in this example calculates differences between the pixel values of the block of interest and the predicted values for each color component and compares the differences calculated for the color components to the tolerances set for each color component. If the differences for all color components fall within the tolerances, the prediction error decision part 554 permits changing the data set values of the block of interest; if the difference for any color component goes beyond its tolerance, it inhibits replacing the data set values of the block of interest by the predicted data (data set values) of this reference block.

While a decision of whether to change the values in a data set including plural color components is made in this example, this decision is not limited so. For example, the prediction error decision part 554 may determine whether to change or inhibit a pixel value change for each color component, according to the tolerances set for each color component. In this case, a pixel value change is made on a component-by-component basis.

The pixel value change operation part 556 changes the data values of the block area of interest, according to the result of decision made by the prediction error decision part 554.

More specifically, if changing the data values is permitted by the prediction error decision part 554, the pixel value change operation part 556 changes the data values of the block area of interest so that the hit rate of predictions to be made by the predictive coding part 530 (in FIG. 8) will increase. If a gradation value change is inhibited by the prediction error decision part 554, the pixel value change operation part 516 outputs the input data values of the block area of interest as they are.

If a pixel value change is permitted for all color components by the prediction error decision part 554, the pixel value change operation part 556 in this example replaces the data set values of the block X of interest by the predicted values (data set values of a reference block) with the smallest difference. If a pixel value change is inhibited for any color component by the prediction error decision part 554, the pixel value change operation part 556 outputs the data set values of the block X of interest as they are.

If the prediction error decision part 554 determines whether to permit or inhibit a pixel value change for each color component, the pixel value change operation part 556 may change each pixel component value (that is, a part of the data set), according to the result of decision made for each color component by the prediction error decision part 554.

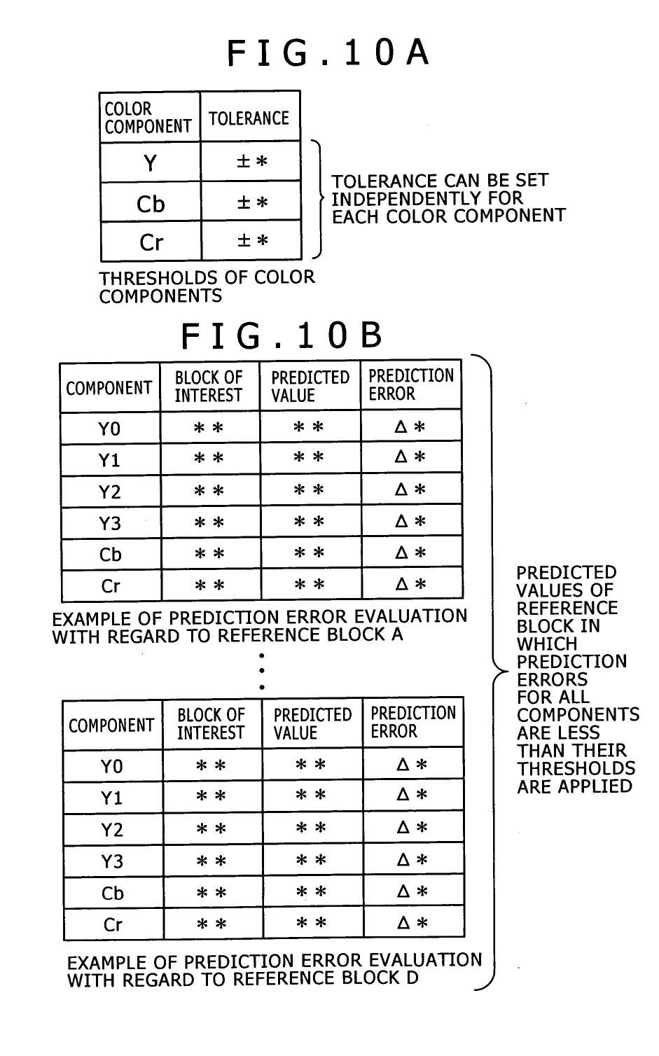

FIGS. 10A and 10B explain a prediction error decision operation by the prediction error decision part 554 (in FIG. 9), wherein FIG. 10A illustrates the tolerances set for each color component and FIG. 10B illustrates examples of prediction error evaluation made by the prediction error decision part 554.

As illustrated in FIG. 10A, the prediction error decision part 554 sets a tolerance within which a pixel value change is permitted independently for each of the Y, Cb, and Cr components. The tolerance for the Y component may be smaller (i.e., a narrower tolerance) than the tolerances for the Cb and Cr components.

As illustrated in FIG. 10B, the prediction error decision part 554 in this example compares the data set values of the block X of interest to all predicted values for this block X of interest (that is, the data set values of the reference blocks A to D in FIG. 5A) and calculates differences (prediction errors) for each component. Thus, differences (prediction errors) for Y0 to Y3, Cb, and Cr components of the pixel are calculated.

For a reference block, the prediction error decision part 554 compares each of the differences (prediction errors) thus calculated for the components to the appropriate one of the tolerances set for each color component (FIG. 10A). If the differences for all color components fall within their tolerances, the prediction error decision part 554 permits changing the data set values of the block X of interest with those (predicted values) of this reference block; if a difference for any color component is greater than its tolerance, it inhibits changing the data set values with those of this reference block.

As above, the prediction error decision part 554 determines whether to permit or inhibit a pixel value change with regard to each reference block (predicted values).

Also, the prediction error decision part 554 in this example, if it determines that a pixel value change can be permitted with regard to plural reference blocks (predicted values), selects one of the reference blocks (predicted values) according to predetermined priority, and notifies the pixel value change operation part 556 of the selected reference block (predicted values). Then, the pixel value change operation part 556 replaces the data set values of the block X of interest by the data set values (predicted values) of the reference block notified from the prediction error decision part 554.

The prediction error decision part 554, if it determines that changing the data set values can be permitted with regard to plural reference blocks (predicted values), may select one of the reference blocks (predicted values), based on the prediction error for one color component and the tolerance set for that color component. For example, the prediction error decision part 554 can calculate a ratio of the prediction error to the tolerance for the Y0 to Y3 components for all reference blocks and select a reference block (predicted values) in which this ratio of the prediction error to the tolerance is the smallest.

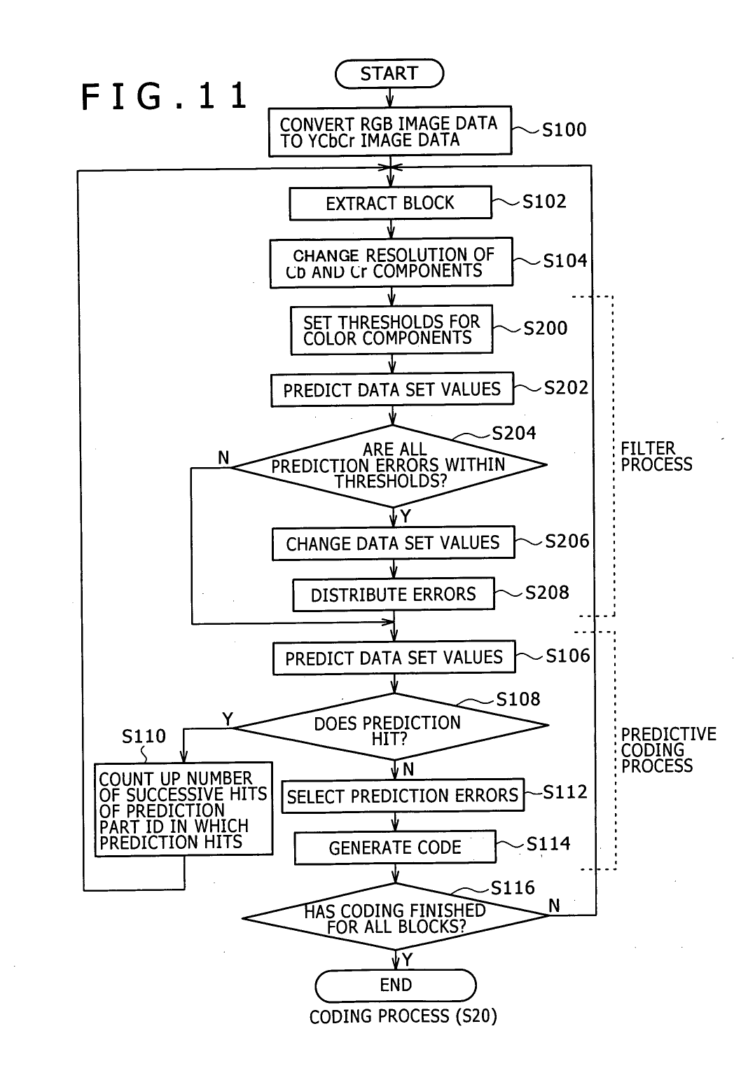

FIG. 11 is a flowchart of a coding process (S20) by the second coding program 6 (FIG. 8). Steps shown in this figure, which are substantially identical to those shown in FIG. 6, are assigned the same reference numbers.

As illustrated in FIG. 11, at step S100, the color conversion part 500 (in FIG. 8) converts input image data (image data in the RGB color space) into image data in the YCbCr color space and outputs the converted image data (image data in the YCbCr color space) to the block extracting part 510.

At step S102, the block extracting part 510 (in FIG. 8) selects a block of 2 by 2 pixels (FIG. 3A) in reading order out of the image data, input from the color conversion part 500, and sets the selected block as the block X of interest.

The block extracting part 510 sorts and arranges the pixel values (Y, Cb, and Cr components) of the pixels constituting the block X of interest by color component, thus generating a data set 900 before subjected to resolution changing (FIG. 3B), and outputs the generated data set 900 to the resolution decreasing part 520.

At step S104, the resolution decreasing part 520 generates the Cb components portion and the Cr components portion of the data set 900 (before resolution changing) input from the block extracting part 510, to a Cb component and a Cr component with decreased resolution, thus generating a data set 902 after subjected to resolution changing (FIG. 3C), and outputs this data set 902 to the filter processing part 550.

At step 200 (S200), the prediction error decision part 554 (in FIG. 9) in the filter processing part 550 (in FIG. 8) reads the tolerances for the Y, Cb, and Cr components from a table prepared in advance.

The prediction error decision part 554 may set the tolerances for each color component (Y, Cb, and Cr components), according to entered image attributes.

At step 202 (S202), the predicted value provision part 552 generates plural predicted data pieces (predicted values in plural data sets) by referring to plural reference blocks A to D for the block X of interest and outputs the generated predicted data to the prediction error decision part 554.

At step 204 (S204), the prediction error decision part 554 (in FIG. 9) compares the predicted data, input from the predicted value provision part 552, to the data set values of the block of interest, and calculates differences (prediction errors) for each component.

Then, the prediction error decision part 554 compares the differences (prediction errors) calculated for each reference block and each of the plural components to the tolerances set for each color component. As a result of decision with regard to a reference block, if the differences for all components fall within the tolerances, the prediction error decision part 554 permits changing the data set values with those of this reference block; if a difference for any color component goes beyond its tolerance, it inhibits changing the data set values with those of this reference block.

If changing the data set values is permitted with regard to at least one reference block, the prediction error decision part 554 selects that one reference block and notifies the pixel value change operation part 556 of the selected reference block. Then, the process proceeds to step S206. If changing the data set values is inhibited for all reference blocks, the prediction error decision part 554 outputs the data set values of the block X of interest as they are to the predictive coding part 530 (in FIG. 8). Then, the process proceeds to step S106.

At step 206 (S206), the pixel value change operation part 556 (in FIG. 9) replaces the data set values of the block X of interest by the data set values of the reference block notified from the prediction error decision part 554 and outputs the data set values to the predictive coding part 530.

At step 208 (S208), the pixel value change operation part 556 distributes errors resulting from the replacement of the data set values (that is, differences between the data set values of the reference block selected by the prediction error decision part 554 and the data set values of the block of interest) to the blocks surrounding the block of interest.

This suppresses tone unevenness by the change of the data set values in the whole image.

At step S106, the plural prediction parts 532 (in FIG. 4) provided in the predictive coding part 530 generate predicted data (data set values) for the block of interest, using the data set values of a block which have previously been input from the filter processing part 550 and buffered.

Meanwhile, the prediction error calculation part 534 (in FIG. 4) calculates differences between the data set values of the block of interest, which have been newly input, and the data set values of the reference block A, and outputs the calculated differences as prediction errors to the selecting part 538.

At step S108, each prediction part 532 (in FIG. 4) compares the generated predicted data (the data set values of a reference block) to the data set values of the block X of interest, determines whether a match occurs, and outputs the result of the decision (the prediction part ID if the match occurs or a mismatch result) to the run counting part 536. If the data set values of the block X of interest have been replaced by the data set values of the appropriate reference block at the step S206, a prediction hit will occur and the relevant prediction part ID will be output.

If the match between the data set values of the block X of interest and the predicted data occurs in any prediction part 532, the coding program 52 proceeds to step S110. If the match does not occur in any of the prediction parts 532, the coding program 52 proceeds to step S112.

At step S110, the run counting part 536 (in FIG. 4), when taking a prediction part ID input from any prediction part 532, increments the count value for the prediction part ID by one.

Then, the coding program 52 returns to S102 to perform the process for the next block.

At step S112, upon detecting that no prediction hits occur in any of the prediction parts 532, according to the results input from the prediction parts 532, the run counting part 536 outputs respective counts of all prediction part IDs to the selecting part 538.

When taking the input of the count values of all prediction part IDs from the run counting part 536, the selecting part 538 determines the greatest number of successive hits of a prediction part ID from the count values which have been input and outputs the greatest number of successive hits and the prediction part ID to the code generating part 540.

Then, the selecting part 538 outputs the prediction errors (i.e., prediction errors for the block X of interest for which no hits have occurred with the predictions made by any of the prediction parts 532), which have been input from the prediction error calculation part 534, to the code generating part 540.

At step S114, the code generating part 540 (in FIG. 4) codes the prediction part ID, the number of successive hits, and the prediction errors which have been input in order from the selecting part 538 and outputs coded data to the communication device 22 (in FIG. 1) or the recoding device 24 (in FIG. 1).

At step S116, the coding program 52 (FIG. 8) determines whether coding has finished for all blocks in the input image data. If there are one or more blocks for which coding is unfinished, the program returns to step S102 and repeats the process for the next block; otherwise, it ends the coding process (S20).

As described above, the image processing apparatus 2 of this modification example achieves a higher compression rate by the filter processing part 550 and its lossy processing (replacement of data set values) that increases the hit rate of predictions made by the prediction parts 532 (in FIG. 4).

In this modification example, filter processing by the filter processing part 550 is performed after generating a data set 902 (FIG. 3C); however, the coding process of the present invention is not limited so. For instance, it may be carried out that, after the filter processing part 550 performs filter processing on the whole input image data, the block extracting part 510 generates a data set 900 (before resolution changing), and the resolution decreasing part 520 executes resolution changing on the data set.

### OTHER MODIFICATION EXAMPLES

In the foregoing embodiment, a data set 902 (FIG. 3C) generated by the block extracting part 510 and the resolution decreasing part 520 is coded in accordance with a predictive coding method by the predictive coding part 530; however, the coding method is not limited so. Diverse coding methods capable of coding values in a data set into a single value can be applied.

The data set 902 (FIG. 3C) generated by the block extracting part 510 and the resolution decreasing part 520 can be regarded as the one that has been compressed by data compression processing (because the Cb and Cr components have been reduced) and this data set 902 may be transmitted and received or stored as compressed data.

[Image Processing Apparatus]

As described above, an image processing apparatus of an aspect of the present invention includes an extracting unit that extracts a pixel cluster of a predetermined size from input image data and a coding unit that codes the input image data, based on correlation between pixel clusters extracted by the extracting unit.

The coding unit may compare one pixel cluster to another pixel cluster extracted by the extracting unit and codes matching result data with regard to gradation values of the pixel clusters.

Each of the pixel clusters may include plural gradation values, and the coding unit may compare the plurality of gradation values of one pixel cluster to a plurality of gradation values of another pixel cluster extracted. If differences between the gradation values of one pixel cluster and the gradation values of the other pixel cluster fall within tolerances predetermined for the gradation values, the coding unit may code data representing a match between the gradation values of both. And, if the differences go beyond the tolerances, the coding unit may code the differences.

A pixel included in the pixel cluster may include gradation values of a plurality of color components. The image processing apparatus may further include a resolution changing unit that changes resolution of some of the plurality of color components of the input image data, and the coding unit may code image data in which the resolution of some of the color components has been changed by the resolution changing unit.

The resolution changing unit may decrease the resolution of a color difference component of the input image data.

The resolution changing unit may change the resolution by each pixel cluster extracted by the extracting unit.

Also, an image compression apparatus of another aspect of the present invention includes an extracting unit that extracts a pixel cluster of a predetermined number of pixels from input image data, and a resolution changing unit that changes resolution of some of a plurality of color components of the input image data, by each pixel cluster extracted by the extracting unit.

And, an image processing apparatus according to yet another aspect of the present invention includes a decoding unit that decodes a coded image data to generates a data set, which represents gradation values of pixels of image data, based on correlation between the decoded data; and a data dividing unit that divides values of the data set to extract gradation values of a plurality of pixels.

The data dividing unit may extract gradation values of a plurality of color components for each pixel, and the image processing apparatus may further include a resolution changing unit that performs resolution changing on the gradation values of some of the color components extracted by the data dividing unit.

[Image Processing Method]

An image processing method of an aspect of the present invention extracts a pixel cluster of a predetermined size from input image data and codes the input image data, based on correlation between pixel clusters extracted.

An image processing method of another aspect of the present invention includes decoding a coded data to generate a data set, which represents gradation values of pixels of image data, based on correlation between the decoded data; and dividing values of the data set to extract gradation values of a plurality of pixels.

An image processing method of yet another aspect of the present invention includes extracting a pixel cluster of a predetermined number of pixels from input image data; and generating a data set which represents gradation values of pixels of image data. The data set may include a plurality of gradation values of a first color component, and a fewer number of gradation values of a second color component than the gradation values of the first color component.

The gradation values of the first color component may correspond to a plurality of pixels neighboring each other, and the gradation values of the second color component may correspond to a result of a calculation in regard with gradation values of the plurality of pixels neighboring each other.

The data set may be a bit sequence in which the plurality of gradation values of the first color component and the gradation values of other color components are arranged sequentially.

The first color component may be a luminance component, and the second color component may be a color difference component.

An image processing method according to another aspect of the present invention includes extracting a pixel cluster of a predetermined number of pixels from input image data; and changing resolution of some of a plurality of color components of the image data, by each pixel cluster extracted by the extracting unit.

[Medium Storing a Program]

A storage medium according to an aspect of the present invention, readable by a computer, stores a program of instructions causing the computer to extract a pixel cluster of a predetermined size from input image data and to code the input image data, based on correlation between pixel clusters extracted.

A storage medium according to another aspect of the present invention, readable by a computer, stores a program of instructions causing the computer to decode a coded data to generate a data set, which represents gradation values of pixels of image data, based on correlation between the decoded data; and to divide values of the data set to extract gradation values of a plurality of pixels.

A storage medium according to yet another aspect of the present invention, readable by a computer, stores a program of instructions causing the computer to extract a pixel cluster of a predetermined number of pixels from input image data; and to change resolution of some of a plurality of color components of the image data, by each pixel cluster extracted by the extracting unit.

The present invention may be embodied in other specific forms without departing from its spirit or characteristics. The described embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

The entire disclosure of Japanese Patent Application No. 2005-083505 filed on Mar. 23, 2005 including specification, claims, drawings and abstract is incorporated herein by reference in its entirety.

What is claimed is:

1. An image processing apparatus comprising:
an extracting unit that extracts a pixel cluster of a predetermined size from input image data; and
a coding unit that codes the input image data, based on correlation between pixel clusters extracted by the extracting unit.

2. The image processing apparatus according to claim 1, wherein the coding unit compares one pixel cluster to another pixel cluster extracted by the extracting unit and codes matching result data with regard to gradation values of the pixel clusters.

3. The image processing apparatus according to claim 2,
wherein each of the pixel clusters comprises a plurality of gradation values, and
the coding unit compares the plurality of gradation values of one pixel cluster to a plurality of gradation values of another pixel cluster extracted, if differences between the gradation values of one pixel cluster and the gradation values of the other pixel cluster fall within tolerances predetermined for the gradation values, codes data representing a match between the gradation values of both, and, if the differences go beyond the tolerances, codes the differences.

4. The image processing apparatus according to claim 1, wherein
a pixel included in the pixel cluster comprises gradation values of a plurality of color components,
the image processing apparatus further comprises a resolution changing unit that changes resolution of some of the plurality of color components of the input image data, and
the coding unit codes image data in which the resolution of some of the color components has been changed by the resolution changing unit.

5. The image processing apparatus according to claim 4, wherein the resolution changing unit decreases the resolution of a color difference component of the input image data.

6. The image processing apparatus according to claim 4, wherein the resolution changing unit changes the resolution by each pixel cluster extracted by the extracting unit.

7. An image processing apparatus comprising:
an extracting unit that extracts a pixel cluster of a predetermined number of pixels from input image data; and
a resolution changing unit that changes resolution of some of a plurality of color components of the input image data, by each pixel cluster extracted by the extracting unit.

8. An image processing apparatus comprising:
a decoding unit that decodes a coded image data to generates a data set, which represents gradation values of pixels of image data, based on correlation between the decoded data; and
a data dividing unit that divides values of the data set to extract gradation values of a plurality of pixels.

9. The image processing apparatus according to claim 8, wherein
the data dividing unit extracts gradation values of a plurality of color components for each pixel, and
the image processing apparatus further comprises a resolution changing unit that performs resolution changing on the gradation values of some of the color components extracted by the data dividing unit.

10. An image processing method comprising:
extracting a pixel cluster of a predetermined number of pixels from input image data; and
generating a data set which represents gradation values of pixels of image data; wherein
the data set includes a plurality of gradation values of a first color component, and a fewer number of gradation values of a second color component than the gradation values of the first color component.

11. The image processing method according to claim 10, wherein
the gradation values of the first color component correspond to a plurality of pixels neighboring each other, and the gradation values of the second color component correspond to a result of a calculation in regard with gradation values of the plurality of pixels neighboring each other.

12. The image processing method according to claim 10, wherein the data set is a bit sequence in which the plurality of gradation values of the first color component and the gradation values of other color components are arranged sequentially.

13. The image processing method according to claim 10, wherein
the first color component is a luminance component, and
the second color component is a color difference component.

14. An image processing method comprising:
extracting a pixel cluster of a predetermined-size from input image data; and
coding the input image data, based on correlation between pixel clusters extracted.

15. An image processing method comprising:
decoding a coded data to generate a data set, which represents gradation values of pixels of image data, based on correlation between the decoded data; and
dividing values of the data set to extract gradation values of a plurality of pixels.

16. A storage medium readable by a computer, the storage medium storing a program executable by the computer to perform a function comprising:
extracting a pixel cluster of a predetermined size from input image data; and
coding the input image data, based on correlation between pixel clusters extracted.

17. A storage medium readable by a computer, the storage medium storing a program of instructions executable by the computer to perform a function comprising:
decoding a coded data to generate a data set, which represents gradation values of pixels of image data, based on correlation between the decoded data; and
dividing values of the data set to extract gradation values of a plurality of pixels.

18. An image processing method comprising:
extracting a pixel cluster of a predetermined number of pixels from input image data; and
changing resolution of some of a plurality of color components of the image data, by each pixel cluster extracted by the extracting unit.

19. A storage medium readable by a computer, the storage medium storing a program of instruction executable by the computer to perform the computer a function comprising:
extracting a pixel cluster of a predetermined number of pixels from input image data; and
changing resolution of some of a plurality of color components of the image data, by each pixel cluster extracted by the extracting unit.
